(19) United States
(12) Patent Application Publication
(10) Pub. No.: US 2017/0180868 A1
(43) Pub. Date: Jun. 22, 2017

(54) LOUDSPEAKER

(71) Applicant: Panasonic Intellectual Property Management Co., Ltd., Osaka (JP)

(72) Inventors: MITSUKAZU KUZE, Osaka (JP); HIDEAKI INOUE, Mie (JP); SATOSHI KOURA, Osaka (JP); TOMONORI SHIBUYA, Osaka (JP); TAKAYUKI DAN, Osaka (JP)

(21) Appl. No.: 15/301,449

(22) PCT Filed: Sep. 14, 2015
(86) PCT No.: PCT/JP2015/004666

§ 371 Date: Oct. 3, 2016

(30) Foreign Application Priority Data
Oct. 3, 2014 (JP) 2014-204401

(51) Int. Cl. H04R 9/02

(52) U.S. Cl. CPC H04R 9/025; H04R 9/02

(57) ABSTRACT

A loudspeaker includes a frame, a diaphragm, a magnetic circuit, a voice coil body, and a cover. The magnetic circuit includes a first surface facing a diaphragm, a second surface opposite to the first surface, a magnetic gap, a through-hole, and a first corner portion. The through-hole penetrates between the first surface and the second surface. The first corner portion has a first radius of curvature, and formed in such a manner as to extend over a section facing the through-hole and at least one of the first surface and the second surface. The cover has a second corner portion having a second radius of curvature larger than the first radius of curvature, and formed so as to cover at least a part of the first corner portion.

### TECHNICAL FIELD

The present disclosure relates to a loudspeaker used in various electronic devices.

### BACKGROUND ART

A conventional loudspeaker is described hereinafter with reference to a drawing. FIG. 3 is a sectional schematic view of conventional loudspeaker 1. Loudspeaker 1 includes diaphragm 3, metal frame 4, voice coil body 30, and magnetic circuit 7. Diaphragm 3 is provided with dust cap 2. Metal frame 4 holds diaphragm 3. Voice coil body 30 includes coil bobbin 5 and voice coil 6. Voice coil 6 is wound around coil bobbin 5. Coil bobbin 5 is linked to diaphragm 3. Magnetic circuit 7 has through-hole 8.

When an electric current is allowed to flow through voice coil 6, magnetic circuit 7 allows coil bobbin 5 to vibrate. Then, diaphragm 3 vibrates via coil bobbin 5, and a sound is played back. When diaphragm 3 vibrates, air around magnetic circuit 7 moves in and out through through-hole 8.

Formation of through-hole 8 prevents air from being sealed around magnetic circuit 7 (in particular, in space formed by diaphragm 3 and magnetic circuit 7 via voice coil body 30). That is to say, the formation of through-hole 8 prevents vibration of diaphragm 3 from being limited by the sealing of the space.

Note here that information on prior art document relating to the invention of this application is, for example, PTL 1.

### CITATION LIST

### Patent Literature

PTL 1: Japanese Patent Application Unexamined Publication No. 2002-271889

### SUMMARY OF THE INVENTION

A loudspeaker includes a frame, a diaphragm, a magnetic circuit, a voice coil body, and a cover.

The frame has inner space.

The diaphragm is disposed in the inner space of the frame.

The magnetic circuit includes a first surface facing a diaphragm, a second surface opposite to the first surface, a magnetic gap, a through-hole, and a first corner portion. The magnetic gap is formed on the first surface. The through-hole penetrates between and the first surface and the second surface. The first corner portion had a first radius of curvature, and is formed in such a manner as to extend over a section facing the through-hole and at least one of the first surface and the second surface.

The voice coil body includes a first end portion and a second end portion opposite to the first end portion. The first end portion is connected to the diaphragm. The second end portion is disposed in the magnetic gap.

The cover has a second corner portion having a second radius of curvature larger than the first radius of curvature, and is formed so as to cover at least a part of the first corner portion.

### BRIEF DESCRIPTION OF THE DRAWINGS

FIG. 1 is a sectional schematic view showing a configuration of a loudspeaker in accordance with an exemplary embodiment.

FIG. 2 is a sectional schematic view showing a configuration of another loudspeaker in accordance with the exemplary embodiment.

FIG. 3 is a sectional schematic view of a conventional loudspeaker.

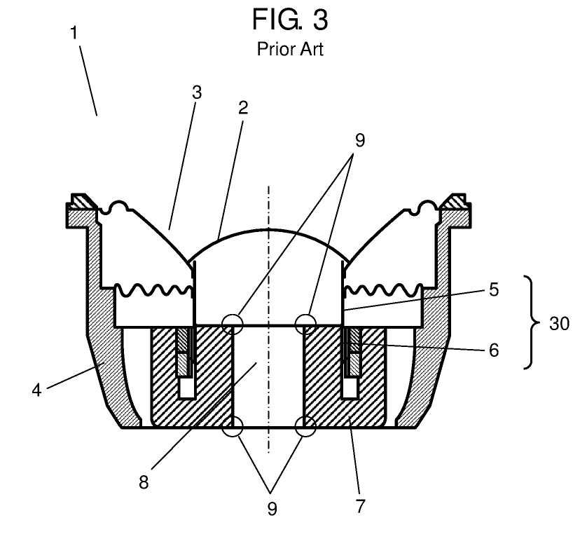

### DESCRIPTION OF EMBODIMENTS

Magnetic circuit 7 of conventional loudspeaker 1 has substantially right-angled sharp end portion 9 on the side facing through-hole 8. Accordingly, turbulence easily occurs in the air moving in and out through through-hole 8. Then, the turbulence in the air moving in and out through through-hole 8 may cause noise to occur.

Hereinafter, the exemplary embodiment is described with reference to drawings.

### Exemplary Embodiment

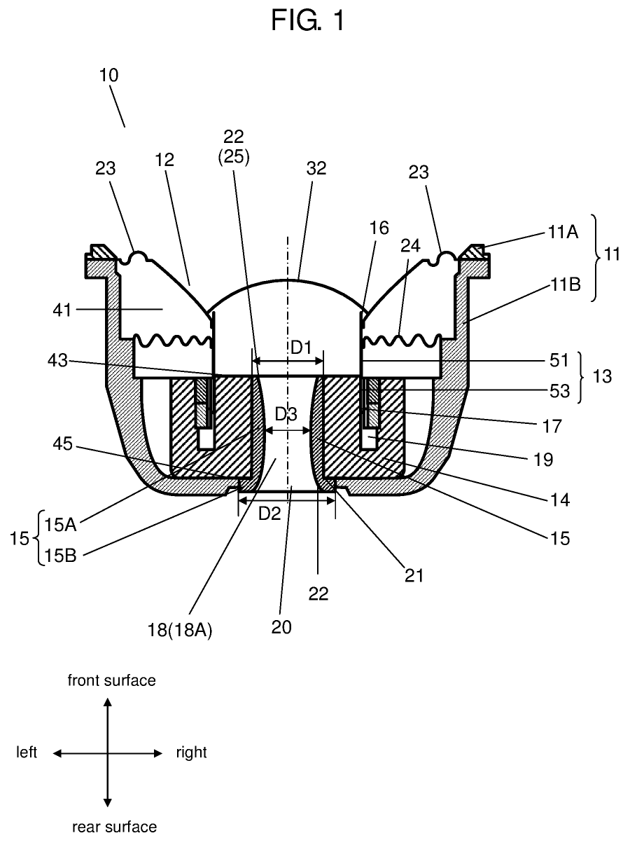

FIG. 1 is a sectional schematic view showing a configuration of loudspeaker 10 in accordance with an exemplary embodiment.

Loudspeaker 10 includes frame 11, diaphragm 12, magnetic circuit 14, voice coil body 13, and cover 15.

Frame 11 has inner space 41.

Diaphragm 12 is disposed in inner space 41 of frame 11.

Magnetic circuit 14 includes first surface 43 facing diaphragm 12, second surface 45 opposite to first surface 43, magnetic gap 19, through-hole 18, and first corner portion 21. Magnetic gap 19 is formed on first surface 43. Through-hole 18 penetrates between first surface 43 and second surface 45. First corner portion 21 has a first radius of curvature, and is formed in such a manner as to extend over a section facing through-hole 18 and at least one of first surface 43 and second surface 45.

Voice coil body 13 includes first end portion 16 and second end portion 17 opposite to first end portion 16. First end portion 16 is connected to diaphragm 12. Second end portion 17 is disposed in magnetic gap 19.

Cover 15 has second corner portion 22 having a second radius of curvature larger than the first radius of curvature, and is formed so as to cover at least a part of first corner portion 21.

Hereinafter, details of loudspeaker 10 are described. Loudspeaker 10 includes frame 11, diaphragm 12, voice coil body 13, magnetic circuit 14, and cover 15. Diaphragm 12 is provided with dust cap 32. Voice coil body 13 includes coil bobbin 51 and voice coil 53. Voice coil 53 is wound around coil bobbin 51.

Diaphragm 12 is linked to frame 11. Voice coil body 13 has first end portion 16 and second end portion 17. First end portion 16 is bonded to diaphragm 12. Magnetic circuit 14 has through-hole 18 and magnetic gap 19. Through-hole 18 penetrates from a front surface (first surface 43) of magnetic circuit 14 to a rear surface (second surface 45) that is opposite to the front surface of magnetic circuit 14. First corner portion 21 formed to have the first radius of curvature is provided in the periphery of opening portion 20 of through-hole 18. Second end portion 17 of voice coil body 13 is inserted into magnetic gap 19 of magnetic circuit 14. Cover 15 is in contact with the rear surface of magnetic circuit 14. Cover 15 has second corner portion 22 having the second radius of curvature larger than the first radius of curvature.

The formation of through-hole 18 prevents space formed by diaphragm 12 and magnetic circuit 14 via voice coil body 13 from being sealed. When diaphragm 12 vibrates, air moves in and out through through-hole 18. Therefore, diaphragm 12, in a state in which distortion is suppressed, vibrates and plays back a sound.

At opening portion 20 of through-hole 18, second corner portion 22 of cover 15, which is inserted into through-hole 18 and covers through-hole 18, is formed to have the second radius of curvature larger than the first radius of curvature of first corner portion 21. Consequently, when air moves in and out through through-hole 18, occurrence of turbulence of air is suppressed in second corner portion 22. As a result, in through-hole 18 of loudspeaker 10, noise caused by the turbulence of air is reduced.

Furthermore, cover 15 easily absorbs mechanical vibration of magnetic circuit 14, and, therefore, noise of loudspeaker 10 due to vibration of magnetic circuit 14 is reduced.

Next, a configuration of loudspeaker 10 is described in more detail.

Coil bobbin 51 has a cylindrical shape. Diaphragm 12 is linked to the outer circumferential surface of first end portion 16 of coil bobbin 51.

Magnetic gap 19 is formed on first surface 43 of magnetic circuit 14. Second end portion 17 of coil bobbin 51 is disposed in magnetic gap 19. When a driving circuit (not shown) allows an electric current to flow through voice coil 53, magnetic circuit 14 vibrates coil bobbin 51. In response to the movement of coil bobbin 51, diaphragm 12 vibrates. Herein, diaphragm 12 is linked to coil bobbin 51. Furthermore, diaphragm 12 is held by frame 11 via diaphragm edge 23.

Furthermore, magnetic circuit 14 has through-hole 18 penetrating from a front surface to a rear surface of loudspeaker 10. The front surface corresponds to the upper side in the drawing, and the rear surface corresponds to the lower side in the drawing. Cover 15 is provided to cover magnetic circuit 14 from the rear surface of magnetic circuit 14 to the section facing through-hole 18 of magnetic circuit 14. Herein, cover 15 may cover the entire surface of the rear surface and the side surface of magnetic circuit 14, or may cover a part of magnetic circuit 14 in the vicinity of opening portion 20 of through-hole 18.

In opening portion 20 of through-hole 18, the second radius of curvature of second corner portion 22 of cover 15 is larger than the first radius of curvature of first corner portion 21 of magnetic circuit 14. Furthermore, cover 15 projects toward the axis of through-hole 18 in the vicinity in the middle in the axial direction of through-hole 18. Through-hole 18 and through-space 18A formed by cover 15 become constricted in the vicinity in the middle in the axial direction of through-hole 18. Through-hole 18 or through-space 18A is linked to space surrounded by diaphragm 12 and voice coil body 13.

With this configuration, even when diaphragm 12 vibrates with a large amplitude in a case where a loud sound is generated, diaphragm 12 does not vibrate in a state in which diaphragm 12 and voice coil body 13 have sealed space in which pressure varies. That is to say, when diaphragm 12 vibrates, air moves in and out through through-hole 18. Consequently, distortion when diaphragm 12 vibrates is suppressed.

Furthermore, in opening portion 20 of through-hole 18, the second radius of curvature of second corner portion 22 of cover 15 at a portion covering first corner portion 21 of magnetic circuit 14 is larger than the first radius of curvature of first corner portion 21. Therefore, when air moves in and out through through-hole 18, occurrence of the turbulence of air is suppressed in second corner portion 22. As a result, noise generated at through-hole 18 of loudspeaker 10 is reduced.

FIG. 1 shows one example in which first corner portion 21 of magnetic circuit 14 and second corner portion 22 of cover 15 are provided on the rear surface (second surface 45) of magnetic circuit 14, that is, in the vicinity of opening portion 20. However, on the front surface (first surface 43) of magnetic circuit 14, cover 15 may be formed such that the second radius of curvature of second corner portion 22 is larger than the first radius of curvature of first corner portion 21. Herein, at the front surface side of magnetic circuit 14, second corner portion 22 of cover 15 may not completely cover the corresponding first corner portion 21 of magnetic circuit 14. That is to say, cover 15 may cover a part of magnetic circuit 14 such that all of substantially right-angled sharp first corner portion 21 of magnetic circuit 14 is not exposed, and the second corner portion 22 of cover 15 covering the above-mentioned part may have a curve portion. Alternatively, a part of first corner portion 21 of magnetic circuit 14 may be covered with second corner portion 22, and a curve portion is formed by second corner portion 22 of cover 15 and first corner portion 21 of magnetic circuit 14, and the thus formed curve portion may be formed to have a larger curvature than that of first corner portion 21 of the magnetic circuit.

As shown in FIG. 1, cover 15 not only covers first corner portion 21 of magnetic circuit 14, but also may protrude toward the rear surface of magnetic circuit 14, extend in a hook shape in a cross section so as to cover the rear surface that is an opposite side of magnetic circuit 14 with respect to diaphragm 12. Thus, cover 15 does not have a discontinuous portion that is concave and convex with respect to the air passing through through-hole 18. Consequently, occurrence of turbulence of air is further suppressed, and noise generated in loudspeaker 10 is further reduced.

Furthermore, cover 15 may be formed in such a manner that it is brought into contact with a wall surface of through-hole 18 of magnetic circuit 14, a plurality of surfaces at the opposite side of magnetic circuit 14 with respect to diaphragm 12, that is, the rear surface of magnetic circuit 14, and the other surfaces of magnetic circuit 14. With this configuration, since cover 15 absorbs mechanical vibration of magnetic circuit 14, noise of loudspeaker 10 is further reduced. Cover 15 covering the wall surface of through-hole 18 of magnetic circuit 14 absorbs mechanical vibration mainly in the direction facing through-hole 18 of magnetic circuit 14, that is, in the left-right direction in the drawing. Cover 15 covering the rear surface of magnetic circuit 14 absorbs mechanical vibration mainly in the axial direction of magnetic circuit 14, that is, in the upper-lower direction in the drawing. As a result, noise generated in loudspeaker 10 is further reduced.

That is to say, cover 15 includes cylindrical portion 15A covering through-hole 18 and flange portion 15B covering at least a part of the rear surface in magnetic circuit 14. In other words, in cover 15 having a circular-cylindrical shape, a section formed on the inner periphery of through-hole 18 is cylindrical portion 15A, and a section formed at opening portion 20 is flange portion 15B. Diameter D2 (outer diameter) of flange portion 15B is made larger than diameter D1 (inner diameter) of through-hole 18. That is to say, cover 15 includes cylindrical portion 15A formed in a section facing through-hole 18 and flange portion 15B formed in a section corresponding to first corner portion 21, in magnetic circuit 14. Diameter D2 of flange portion 15B is larger than diameter D1 of through-hole 18 and diameter D3 of cylindrical portion 15A. With this configuration, generation of turbulence of air in through-hole 18 is suppressed, and the mechanical vibration in magnetic circuit 14 is suppressed, and thus noise generated in loudspeaker 10 is reduced.

As mentioned above, cover 15 is continuously provided in such a manner that cover 15 is brought into contact with the wall surface of through-hole 18 and the rear surface of magnetic circuit 14. Thus, cover 15 absorbs mechanical vibration of magnetic circuit 14. Herein, it is preferable that an internal loss of cover 15 is made to be larger than that of magnetic circuit 14 so that mechanical vibration can be efficiently absorbed by cover 15. In particular, since cover 15 does not need large mechanical strength, it is preferable that properties on the internal loss are preferentially determined and material such as resin and metal is determined. Furthermore, cover 15 may be a single structure or may be a structure formed by laminating a plurality of resin layers onto each other.

As mentioned above, cover 15 may have second corner portions 22 having the second radius of curvature on both the front and rear surfaces of magnetic circuit 14. Furthermore, cover 15 may include second corner portion 22 having the second radius of curvature and third corner portion 25 having a third radius of curvature smaller than the second radius of curvature. Herein, second corner portion 22 having the second radius of curvature of cover 15 is formed in such a manner as to extend over the rear surface of magnetic circuit 14 and the section facing through-hole 18. Third corner portion 25 having the third radius of curvature of cover 15 is formed in such a manner as to extend over the front surface of magnetic circuit 14 and in the section facing through-hole 18. Third corner portion 25 covers a part of the corner portion of the corresponding magnetic circuit. When the second radius of curvature of second corner portion 22 provided on the rear surface of magnetic circuit 14 is made larger than the third radius of curvature of third corner portion 25 provided on the front surface of magnetic circuit 14, the flow of the air passing through through-hole 18 is stabilized. As a result, noise generated in loudspeaker 10 is reduced.

With this configuration, a loss of fluid (air) occurring when the fluid passes through through-hole 18 from the rear surface of through-hole 18 is suppressed as compared with a loss of fluid (air) occurring when the fluid passes through through-hole 18 from the front surface of through-hole 18. In general, when air passes through through-hole 18 from the front surface of through-hole 18, the change of the flow passage area of the air is small; but when air passes through through-hole 18 from the rear surface of through-hole 18, the change of the flow passage area of the air becomes larger. Therefore, in the rear surface of through-hole 18, a loss of air as fluid is increased. In this configuration, the second radius of curvature of second corner portion 22 is made to be larger than the third radius of curvature of third corner portion 25, and thereby the increase in the loss is suppressed. Therefore, noise generated in loudspeaker 10 is reduced.

Furthermore, it is preferable that a coefficient of linear expansion of cover 15 is larger than that of magnetic circuit 14. Thus, the degree of adhesion between cover 15 and magnetic circuit 14 is higher when a temperature of loudspeaker 10 is higher as compared with a case where the temperature of loudspeaker 10 is low. Consequently, in a case where the temperature of loudspeaker 10 is higher, cover 15 absorbs mechanical vibration more efficiently. As a result, noise generated in loudspeaker 10 is reduced.

For example, when an electric current is not supplied to loudspeaker 10 and loudspeaker 10 is not operated, or a small amount of electric current is supplied, the temperature of loudspeaker 10 is substantially equal to the environment temperature, the temperature of loudspeaker 10 is not increased. In this state (at ordinary temperature), dimensions of cover 15 and through-hole 18 may be determined so as to have such a low degree of adhesion that cover 15 can be easily inserted into through-hole 18 of magnetic circuit 14. That is to say, in a state in which an electric current is not supplied to loudspeaker 10 and when loudspeaker 10 is not operated, ability of cover 15 to absorb the vibration generated in magnetic circuit 14 may not be set to be high. Furthermore, when cover 15 is inserted into through-hole 18 of magnetic circuit 14, diameter D3 of through-space 18A at a section provided with cover 15 is smaller than diameter D1 of through-hole 18 of magnetic circuit 14.

On the other hand, in an operation state in which a large amount of electric current is supplied to loudspeaker 10, as the increase in temperature of voice coil body 13, temperature of loudspeaker 10 is higher than environmental temperature. Then, the temperature of cover 15 and magnetic circuit 14 are also increased. Even when the degree of adhesion between cover 15 and magnetic circuit 14 is low at an ordinary temperature, since the linear expansion coefficient of cover 15 disposed annularly at the inner side of through-hole 18 is larger than the linear expansion coefficient of magnetic circuit 14 disposed annularly at the outer peripheral side of through-hole 18, cover 15 expands outward larger than magnetic circuit 14. As a result, when loudspeaker 10 is driven and the temperature is increased, and the outer surface of cover 15 further adheres to the inner surface of through-hole 18 of magnetic circuit 14. Therefore, the degree of adhesion between cover 15 and magnetic circuit 14 is improved.

That is to say, in an operation state in which loudspeaker 10 is supplied with a large electric current, the degree of adhesion between cover 15 and magnetic circuit 14 is improved, and thereby the mechanical vibration of magnetic circuit 14 is absorbed by cover 15 more efficiently. As a result, noise generated in loudspeaker 10 is more easily reduced.

In other words, even if the dimension accuracy of cover 15 and magnetic circuit 14 is low, cover 15 and magnetic circuit 14 can be easily assembled in loudspeaker 10. Furthermore, during an operation of loudspeaker 10, cover 15 and magnetic circuit 14 are combined with each other in a state in which they appropriately adhere to each other. That is to say, mechanical vibration of magnetic circuit 14 is absorbed by cover 15 more efficiently.

Furthermore, cover 15 may be bonded to not only a portion that is in contact with magnetic circuit 14, but also the other regions and component elements in loudspeaker 10. For example, cover 15 may be bonded to frame 11 on the rear surface of magnetic circuit 14. Frame 11 for holding diaphragm 12 may be made of metal or resin having a large internal loss. Furthermore, frame 11 may cover diaphragm 12, damper 24, and outer peripheral surface of magnetic circuit 14, and further may hold them. Thus, mechanical vibration of magnetic circuit 14 is absorbed more efficiently by cover 15 and frame 11 made of metal or resin. As a result, noise generated in loudspeaker 10 is more easily reduced.

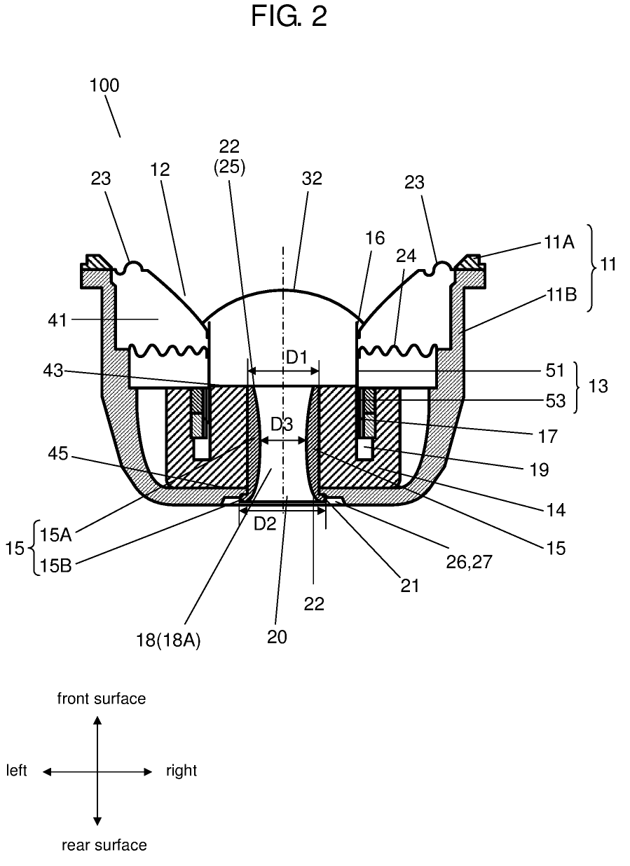

FIG. 2 is a sectional schematic view showing a configuration of loudspeaker 100 in accordance with the exemplary embodiment. Loudspeaker 100 includes second through-hole 26. That is to say, in a case where frame 11 is bonded to cover 15 at the rear surface of magnetic circuit 14, second through-hole 26 may be formed in the rear surface end portion of frame 11. Frame annular portion 27 corresponding to a bottom surface of frame 11 forming second through-hole 26 may be disposed such that it is interposed between flange portion 15B and magnetic circuit 14. Thus, flange portion 15B can cover magnetic circuit 14 or frame 11. As a result, generation of turbulence of the air in through-hole 18 can be suppressed, thus reducing noise generated in loudspeaker 10.

In addition, frame 11 may include first frame 11A and second frame 11B. For example, annular first frame 11A may be provided around diaphragm edge 23 such that annular first frame 11A can hold diaphragm 12 via diaphragm edge 23. First frame 11A may be bonded to second frame 11B at a section where first frame 11A does not hold diaphragm edge 23. Furthermore, cover 15 may be bonded to second frame 11B. It is preferable that an internal loss of second frame 11B is larger than that of first frame 11A. Accordingly, it is preferable that first frame 11A is made of metal, and second frame 11B is formed of resin, or metal having a larger internal loss than that of first frame 11A.

Since first frame 11A, whose shape is not likely to be distorted, is used for the outer periphery of diaphragm edge 23 that is susceptible to stress from diaphragm 12, distortion of vibration of diaphragm 12 for reproducing a sound is also reduced. In addition, first frame 11A, which is not easily distorted in shape but which easily receives vibration from diaphragm 12, is held by second frame 11B. Consequently, vibration and the like generated in first frame 11A is absorbed by second frame 11B. As a result, noise generated in loudspeaker 10 is easily reduced.

Furthermore, since second frame 11B covers the outer periphery of damper 24, magnetic circuit 14, and the like, and further holds them, second frame 11B needs to have mechanical strength. Therefore, it is preferable that the modulus of elasticity of second frame 11B is larger than that of cover 15.

Furthermore, it is preferable that the internal loss of second frame 11B is larger than that of magnetic circuit 14 so that mechanical vibration is efficiently absorbed by second frame 11B.

As mentioned above, according to the present disclosure, turbulence caused by the movement in and out of air is suppressed by the through-hole, and noise generated in the through-hole is reduced.

### INDUSTRIAL APPLICABILITY

A loudspeaker of this disclosure has an advantageous effect that a noise accompanied by the turbulence of air is reduced, and is useful for various electronic devices.

### REFERENCE MARKS IN THE DRAWINGS

1 loudspeaker
2 dust cap
3 diaphragm
4 metal frame
5 coil bobbin
6 voice coil
7 magnetic circuit
8 through-hole
9 end portion
10 loudspeaker
11 frame
11A first frame
11B second frame
12 diaphragm
13 voice coil body
14 magnetic circuit
15 cover
15A cylindrical portion
15B flange portion
16 first end portion
17 second end portion
18 through-hole
18A through-space
19 magnetic gap
20 opening portion
21 first corner portion
22 second corner portion
23 diaphragm edge
24 damper
25 third corner portion
26 second through-hole
27 frame annular portion
30 voice coil body
32 dust cap
41 inner space
43 first surface
45 second surface
51 coil bobbin
53 voice coil
100 loudspeaker
D1 diameter
D2 diameter
D3 diameter

1. A loudspeaker comprising:
a frame having inner space;
a diaphragm disposed in the inner space of the frame;
a magnetic circuit including:
a first surface facing the diaphragm;
a second surface opposite to the first surface;
a magnetic gap formed on the first surface,
a through-hole penetrating between the first surface and the second surface; and
a first corner portion having a first radius of curvature, and formed in such a manner as to extend over a section facing the through-hole and at least one of the first surface and the second surface;
a voice coil body having:
a first end portion bonded to the diaphragm;
a second end portion opposite to the first end portion, and disposed in the magnetic gap and;
a cover having a second corner portion having a second radius of curvature larger than the first radius of curvature, and formed so as to cover at least a part of the first corner portion.

2. The loudspeaker of claim 1, wherein an internal loss of the cover is larger than an internal loss of the magnetic circuit.

3. The loudspeaker of claim 1, wherein the cover is formed of resin, and a coefficient of linear expansion of the cover is larger than a coefficient of linear expansion of the magnetic circuit.

4. The loudspeaker of claim 1, wherein
the diaphragm includes a diaphragm edge, and
the frame includes a first frame for holding the diaphragm via the diaphragm edge, and a second frame bonded to the first frame and the cover.

5. The loudspeaker of claim 4, wherein a modulus of elasticity of the second frame is larger than a modulus of elasticity of the cover.

6. The loudspeaker of claim 4, wherein an internal loss of the second frame is larger than an internal loss of the first frame.

7. The loudspeaker of claim 4, wherein an internal loss of the second frame is larger than an internal loss of the magnetic circuit.

8. The loudspeaker of claim 1, wherein
the first corner portion is formed in such a manner as to extend over the second surface and the section facing the through-hole, and
the cover further includes a third corner portion having a third radius of curvature smaller than the second radius of curvature, and formed in such a manner as to extend over the first surface of the magnetic circuit and the section facing the through-hole.

9. The loudspeaker of claim 1, wherein a part of the frame is in contact with the second surface of the magnetic circuit, and a second through-hole is formed at the frame.

10. The loudspeaker of claim 1, wherein the first corner portion is formed in such a manner as to extend over the second surface and the section facing the through-hole, and the cover is bonded to the frame on the second surface of the magnetic circuit.

11. The loudspeaker of claim 1, wherein the cover includes a cylindrical portion having a circular-cylindrical shape and formed in the section facing the through-hole of the magnetic circuit, and a flange portion formed in a section corresponding to the first corner portion, and a diameter of the flange portion is larger than a diameter of the through-hole.
